(19) United States
(12) Patent Application Publication
(10) Pub. No.: US 2007/0102053 A1
(43) Pub. Date: May 10, 2007

(54) Plumbing fill valve restrictor and regulator apparatus

(76) Inventors: Tuan Le, Diamond Bar, CA (US); Bill DeKeyser, Rancho Santa Margarita, CA (US); Robert Collin, Lake Forest, CA (US)

Correspondence Address: Myers Dawes Andras & Sherman LLP, Suite 1150, 19900 MacArthur Blvd., Irvine, CA, 92612, US

(21) Appl. No.: 11/594,620

(22) Filed: Nov. 8, 2006

Related U.S. Application Data
(60) Provisional application No. 60/736,115, filed on Nov. 10, 2005.

(51) Int. Cl. F15D 1/02

(52) U.S. Cl. 138/43; 138/46; 138/42

(57) ABSTRACT

A toilet fill valve device may function as a restrictor to reduce water flow, or as a regulator to cap water flow beneath a certain limit depending upon its orientation. If composed of a rigid material, the device functions as a restrictor to decrease water flow. If composed of a soft, flexible or compressible/expandable material, the device functions as a regulator as its walls expand to partially block fluid passageways when water pressure fills up a void within the device. The device includes a spiraled outer surface to provide a tortuous path for water to travel so as to reduce noise. The dual functionality of a regulator or restrictor may also be accomplished with the orientation of the device. Methods for manufacturing and using a toilet fill valve control device are also provided.

### RELATED APPLICATIONS

This application relates to, claims priority from, and incorporates herein by reference, as if fully set forth, U.S. Provisional Patent Application Ser. No. 60/736,115 filed on Nov. 10, 2005 and entitled “400 Restrictor/Regulator Scheme.”

### BACKGROUND OF THE INVENTION

1. Field of the Invention

The present invention relates generally to toilet fill valves and more particularly to restrictors for such toilet fill valves.

2. Description of Prior Art and Related Information

Fill valves for toilets provide water from a supply line to a toilet tank and/or bowl. Water pressure and flow rates for these supply lines vary per geographic region. It is common for water pressure in one country or state, for example, to vary from that of another area. Accordingly, even if identical fill valves are installed on toilets in different regions, the volume, flow rate and pressure of incoming water can vary drastically for each toilet. The resulting inconsistency is undesirable particularly when excessive water pressure and/or flow rates lead to high levels of noise and waste of water.

The inconsistency is also undesirable to toilet manufacturers who seek to provide toilets and plumbing systems that perform consistently through a variety of situations and geographic areas, as well as to public/governmental water agencies who seek to conserve water.

While the prior art may include certain devices to decrease, or restrict, water flow in a fill valve, such devices lack the capacity to regulate water flow, namely, to cap the water flow at ceiling. Accordingly, such prior art devices still lead to water waste, albeit at a slower pace, when excessive water pressure from supply lines leads to high flow rates.

Such prior art devices also suffer from the drawback of excessive noise and cavitation. In particular, many prior art devices simply consist of a single hole defined in the passageway of the device to enable water to flow through. This single hole can lead excessive noise as water gushes through the only opening to the rest of the fill valve.

These prior art devices also create cavitation that results from pressure changes in the system. The pressure changes associated with cavitation generate partial vacuums which can lead to the formation of air bubbles, or larger pockets of air, in the water leading out from the fill valve. Accordingly, as such air-filled water travels from the fill valve downstream to other sections of the toilet with greater air pressure, the air pockets will decrease in volume and eventually pop, which results in high noise levels.

Accordingly, it would be desirable to provide a device that restricts or regulates water flow in a fill valve without causing cavitation.

It would also be desirable to provide a device that restricts or regulates water flow in a fill valve while minimizing or reducing noise.

### SUMMARY OF THE INVENTION

The present invention provides structures and methods which overcome the deficiencies in the prior art.

In one aspect, a toilet fill valve control device is provided. The device comprises a hollow body including a closed end and an open end. The hollow body comprises an expandable sidewall, and a tortuous outer surface included in the hollow body. The tortuous outer surface comprises a plurality of flow paths.

The sidewall is preferably composed of an elastomeric material. In the preferred embodiment, the outer surface comprises a spiraled surface that defines a plurality of spiraled flow paths. The device further comprises a fill valve having a vertical conduit with an inner surface. The hollow body is configured to slidingly abut the inner surface of the vertical conduit which defines a fluid passageway. Disposed within the vertical conduit of the fill valve, the hollow body defines an upstream section and a downstream section of the fluid passageway. The hollow body is configured to be disposed within the fill valve in either a first position where the open end faces the upstream section, or a second position where the closed end faces the upstream section.

In another aspect, a toilet fill valve control device comprises a fill valve having a vertical conduit that includes an inner surface and defines a fluid passageway. A hollow flexible body is disposed in the vertical conduit and configured to abut the inner surface of the vertical conduit so as to define an upstream section and a downstream section of the fluid passageway. The hollow body comprises a closed end, an open end and a sidewall. The hollow flexible body is reversible such that it may be oriented in a first position where the open end faces the upstream section, and a second position wherein the closed end faces the upstream section. The hollow body caps a flow rate of fluid in the fill valve in the first position.

The sidewall preferably comprises a plurality of spiraled flow paths. The device further comprises means for providing a tortuous flow path. The means for providing a tortuous flow path may comprise a spiraled outer surface formed on the hollow body. The hollow body is preferably composed of an expandable material. The hollow body is slidingly disposed in the vertical conduit.

In another aspect, a method of manufacturing a fill valve is provided. The method comprises providing a fill valve with a vertical conduit that defines an inner diameter, providing a flexible hollow body having a closed end, an open end and an outer diameter that is substantially similar to the inner diameter of vertical conduit, and disposing the hollow body in the vertical conduit in one of two possible positions.

The step of disposing the hollow body in the vertical conduit in one of two possible positions comprises dividing a passageway of the vertical conduit into an upstream section and a downstream section and either facing the open end of the hollow body toward the upstream section or facing the closed end of the hollow body toward the upstream section.

The step of providing the flexible hollow body having a closed end, an open end and an outer diameter that is substantially similar to the inner diameter of vertical conduit comprises forming the flexible hollow body with a spiraled outer surface.

A method for controlling fluid flow in a toilet fill valve is also provided. The method comprises directing fluid through a vertical conduit of a fill valve, disposing a flexible hollow body in the vertical conduit so as to divide the vertical conduit into an upstream section and a downstream section, capping the flow rate of the fluid in the fill valve by orienting the flexible hollow body in a first position, and reducing a flow rate of the fluid in the fill valve by orienting the flexible hollow body in a second position.

The step of disposing a flexible hollow body in the vertical conduit comprises disposing in the vertical conduit an expandable fluid control device having an open end and a closed end.

The step of reducing the flow rate of the fluid in the fill valve by orienting the flexible hollow body in the second position comprises facing the closed end of the hollow body toward the upstream section.

The step of capping the flow rate of the fluid in the fill valve by orienting the flexible hollow body in the first position comprises facing the open end of the hollow body toward the upstream section. The step of capping the flow rate of the fluid in the fill valve by orienting the flexible hollow body in the first position comprises filling the hollow body with the fluid so as to expand a sidewall of the hollow body against an inner surface of the vertical conduit.

In summary, a toilet fill valve device may function as a restrictor to reduce water flow, or as a regulator to cap water flow beneath a certain limit depending upon its orientation. If composed of a rigid material, the device functions as a restrictor to decrease water flow. If composed of a soft, flexible or compressible/expandable material, the device functions as a regulator as its walls expand to partially block fluid passageways when water pressure fills up a void within the device. The device includes a spiraled outer surface to provide a tortuous path for water to travel so as to reduce noise. The dual functionality of a regulator or restrictor may also be accomplished with the orientation of the device. Methods for manufacturing and using a toilet fill valve control device are also provided.

The invention, now having been briefly summarized, may be better appreciated by the following detailed description.

### BRIEF DESCRIPTION OF THE DRAWINGS

FIG. 1 is a cross-sectional view of a toilet fill valve including a first preferred embodiment of a fill valve control device according to the invention;

FIG. 2 is a cross-sectional operative view of the first preferred embodiment of the fill valve control device in a first orientation;

FIG. 3 is a perspective view of the first preferred embodiment of the fill valve control device;

FIG. 4 is a graph illustrating the regulated flow rate as a result of employing the first preferred fill valve in the first, upright orientation;

FIG. 5 is a cross-sectional operative view of the first preferred embodiment of the fill valve control device in a second orientation;

FIG. 6 is a graph illustrating the restricted flow rate as a result of employing the first preferred fill valve in the second, upside-down orientation;

FIG. 7 is a cross-sectional view of a toilet fill valve including a second preferred embodiment of a fill valve control device according to the invention;

FIG. 8 is a diagram of a preferred method of manufacturing a toilet fill valve; and

FIG. 9 is a diagram of a preferred method for controlling the flow rate of a fluid in a toilet fill valve.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

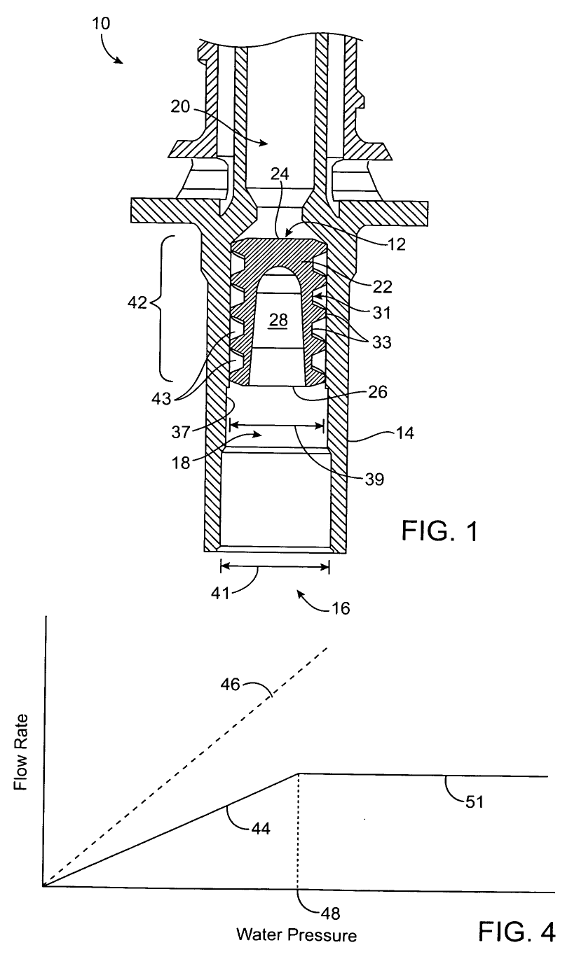

FIG. 1 is a cross-sectional view of a toilet fill valve 10 employing a first preferred embodiment of a fluid control device 12 according to the invention. The fill valve 10 includes a vertical conduit 14 that defines a fluid passageway 16. The fluid control device 12 is disposed in the fluid passageway 16 so as to divide the passageway 16 into an upstream section 18 and a downstream section 20. In the preferred embodiment, the control device 12 may be either slidably or fixedly disposed in the vertical conduit 14. Where the control device 12 is slidably disposed in the vertical conduit 14, the upstream section 18 and downstream section 20 are defined relative to the position of the control device 12.

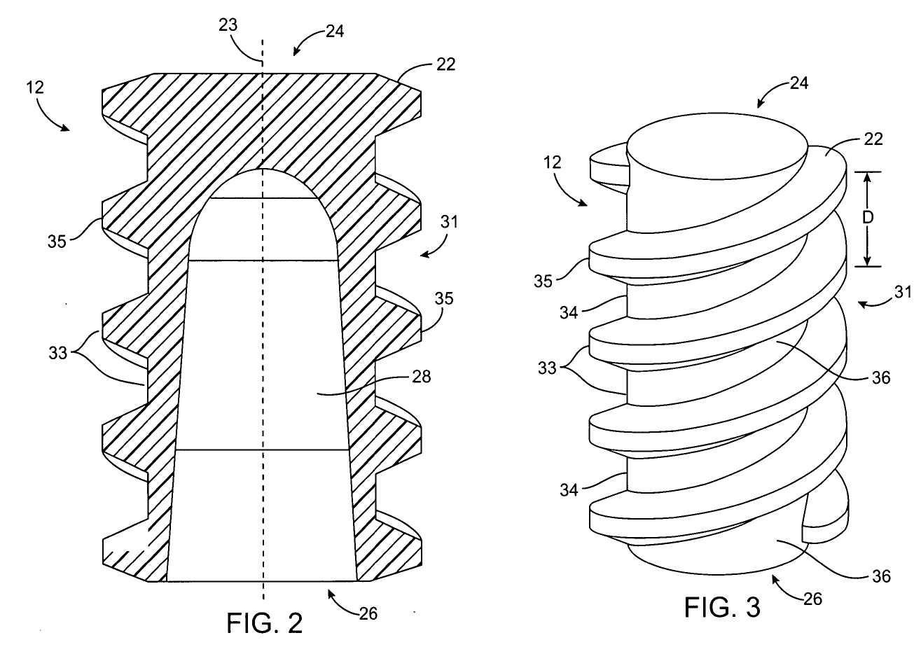

In FIGS. 2 and 3, the fluid control device 12 preferably comprises a hollow body 22 defining an axis 23 and having a closed end 24, an open end, or opening, 26 at an opposite end along the axis 23, and a hollow chamber 28 defined therebetween. The hollow body 22 is preferably composed of an expandable, elastomeric material, such as thermoplastic elastomer or rubber, which will enable a sidewall 31 of the hollow body 22 to expand when the chamber 28 is filled with fluid. The device 12 also comprises an outer surface 33 configured to provide a tortuous fluid flow path so as to reduce, or restrict, the flow rate of fluid passing therethrough. In the preferred embodiment, the device 12 comprises a spiraled surface 33 that includes a helical flange 35 which loosely abuts an inner cylindrical surface 37 of the vertical conduit. causes water to travel one or more tortuous paths between the upstream section 18 and the downstream 20.

In the preferred embodiment shown in FIG. 3, it will be appreciated that the spiraled surface 33 forms two spiraled flow paths or flow channels, 34, 36. The dual flow paths 34, 36 cumulatively provide a greater total distance that water must travel to traverse the device 12 in order to reach the downstream section 20, thereby more effectively reducing the flow rate. A distance “D” defined between the helical flanges 35 determines the amount of buckling that the device 12 will undergo in operation (i.e., lesser distance “D” correlates to lesser buckling).

In an alternative embodiment, the same result may be accomplished with a spiraled surface having a single flow path, but with a longer device 12 so as to provide an extended flow path.

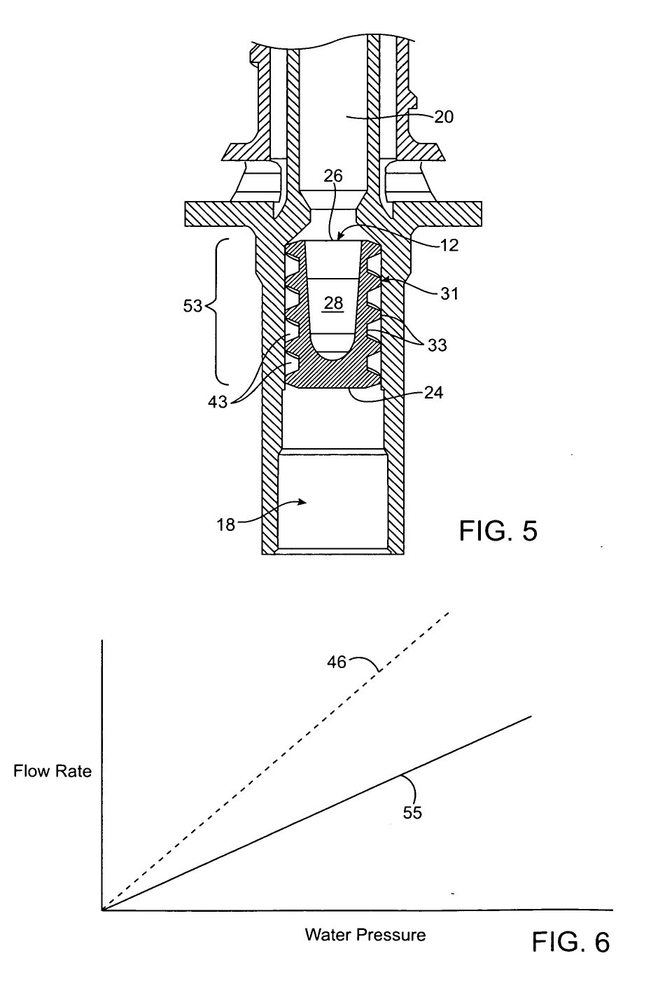

In FIG. 1, the device 12 is configured to be reversible, or reversibly configured, such that it may be positioned in the vertical conduit 14 in one of two positions, or orientations. In the preferred embodiment, the device 12 can fit within the conduit 14 in only those two orientations, namely, a first upright position where the open end 26 faces the upstream passageway section 18, and a second upside-down position where the closed end 24 faces the upstream passageway section 18 as shown in FIG. 5.

It is to be expressly understood that the dual, reversible positions of the device 12 within the vertical conduit 14 may be accomplished in a variety of different ways. In the preferred embodiment shown in FIG. 1 the sidewall 31 of the hollow body 22 is generally cylindrical and formed with an outer-diameter 39 that is slightly less than or substantially equal to the inner diameter 41 of the vertical conduit 14. Accordingly, this provides a sufficiently secure fit when the device 12 is disposed into the vertical conduit 14 in one of the two possible positions such that the device 12, though permitted to slide axially within the passageway 16, cannot rotate or shift away from the orientation in which it is disposed. In other words, if the device 12 is disposed in the conduit 14 in the upright position, the peripheral dimensions of the device 12 are such that the device 12 cannot rotate or somehow move into the upside-down position. Similarly, if placed in the upside-down position, the device 12 cannot be shifted to an upright position within the conduit 14.

FIGS. 1 and 5 show the first preferred fluid control device 12 in operation and illustrate preferred methods of controlling fluid flow rate in a fill valve according to the invention.

In FIG. 1, the fluid control device 12 is disposed in the fill valve 10 and oriented in a first, upright position 42 wherein the open end 26 faces the upstream section 18 (shown as beneath the device) of the fluid passageway 16. A fluid channel space, or flow path space, 43 is defined between the outer surface 33 of the device 12 and the inner surface 37 of the conduit 14. As water is pushed upward through the passageway 16, the water will encounter the upright oriented fluid control device 12, thereby entering the chamber 28 and traveling around the hollow body 22 into the flow path space 43. The water eventually travels upward through the tortuous flow path space 43 provided by the spiraled outer surface 33.

As pressure of the incoming water increases, the water will not only fill the hollow chamber 28 of the device 12, but also cause the sidewall 31 to expand and, thus, more tightly abut the inner conduit surface 37. The expansion of the sidewall 31 caused by higher water pressure reduces the available flow path space 43 through which the incoming water must travel to get past the control device 12. This reduced space 43 in conjunction with the tortuous pathway results in a capping of the flow rate of the incoming at a certain maximum rate. Thus, when the fluid control device 12 is oriented with its open end 26 facing the upstream passageway section 18, the device 12 functions as regulator by not only reducing the water flow, but also capping the water flow rate at a particular maximum when the water pressure exceeds a certain trigger point.

As charted in the graph of FIG. 4, the fluid control device 12 in the upright position will reduce the flow rate of incoming water, indicated by line 44, as compared to an unrestricted flow rate, indicated by line 46. At a predetermined higher water pressure, or the trigger water pressure, 48, the device 12 will expand as described above and thereby cap, or regulate, the flow of incoming water shown by line 51.

As examples and not by way of limitation, the trigger water pressure at which the fluid control device 12 will begin to cap or regulate flow rate may range from 20 pounds per square inch (psi) to 230 psi. As further examples and not by way of limitation, the capped flow rate at such water pressures may be configured at 3 gallons per minute or greater. It is to be expressly understood that the predetermined trigger water pressure may be adjusted by a variety of different ways, such as changing the elasticity of the composition of the device 12, increasing or decreasing the distance between adjacent coils of the helical flange 35, etc.

FIGS. 5 and 6 illustrate the adapter 12 functioning as a restrictor only, namely, that the device 12 reduces, but does not cap, the flow of incoming water through the fill valve 10. In FIG. 5, the fluid control device 12 is oriented in a second, upside-down position 53 where the closed end 24 faces the upstream passageway section 18, and the open end 26 faces the downstream section 20. This orientation 53 generally prevents fluid from filling up the hollow chamber 28, at least not to a point where the sidewall 31 would expand. Instead, water in the upstream section 18 is immediately directed toward the outer adapter surface 33 to the tortuous pathway defined between the spiraled surface 33 and in the inner conduit surface 37. Since the sidewall 31 does not expand in this configuration, the flow path space 43 through which the water must travel to pass the device 12 does not get decreased.

Accordingly, as shown in the FIG. 6, water flow rate indicated by line 55 is simply reduced with respect to the unrestricted rate indicated by line 46 when water pressure increases. However, since capping does not occur when the device 12 is in the upside-down position, the reduced rate 55 will continue to steadily climb without limit as water pressure increases.

It will be appreciated that the preferred embodiment of the fluid control device 12 is reversible in that it may hold dual axial positions, each with a corresponding function. In one position, the device 12 acts as a regulator to reduce water flow and to cap said flow when water pressure reaches a target amount. In an inversed, or axially reversed, position the fluid control device 12 acts as a restrictor to simply reduce water flow without capping. Thus, as described above, the invention comprises preferred methods of controlling fluid flow in a toilet fill valve as well as methods for using a fluid control device in a fill valve.

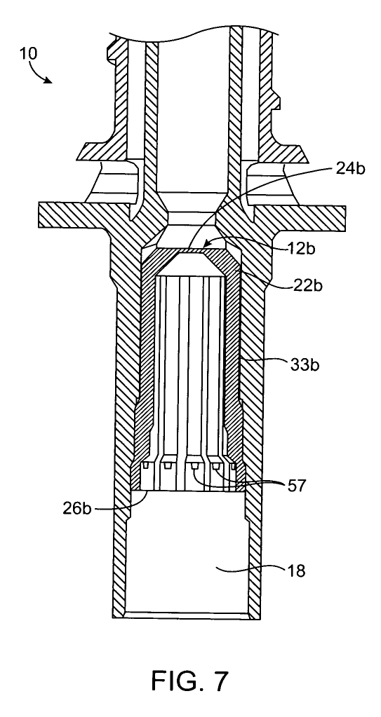

In FIG. 7, a second preferred embodiment of a fill valve control device 12b is illustrated where elements of similar structure are designated by the same reference numerals followed by the lower case “b”. The device 12b is also composed of a flexible, expandable material, such as an elastomer, so that its sidewall 31b may expand when filled with incoming water. The device 12b includes a cylindrical outer surface 33b that is substantially smooth. The hollow body 22b may optionally include a plurality of ports 57 disposed adjacent to the open end 26b, in a radial configuration.

If the device 12b is composed of a soft, flexible material such as an elastomer, then the device 12b can function as both a regulator and restrictor depending upon its orientation, in a manner similar to that of the first embodiment shown in FIGS. 1-6. In particular, by facing the open end 26b toward the upstream section 18, then the device 12b functions as a regulator. In an opposite orientation where the closed end 24b faces the upstream section, the device 12b will function as a restrictor.

A process of manufacturing a restrictor, or regulator is also provided according to the invention. It will be appreciated that varying the function between a restrictor and a regulator with the device 12b in FIG. 7 may be accomplished by forming the device 12b with different materials. In particular, if the device 12b is composed of a soft or flexible material, the device 12b has the capacity to function as a regulator due to the ability of the sidewall 31b to expand when the hollow chamber 28b is filled with water. To make the device 12b work only as a restrictor (regardless of its orientation within the fill valve 10), the device 12b may be manufactured with a rigid material. In such case, the device 12b will only serve to reduce, but not cap, the flow rate since the sidewall 31b will not expand.

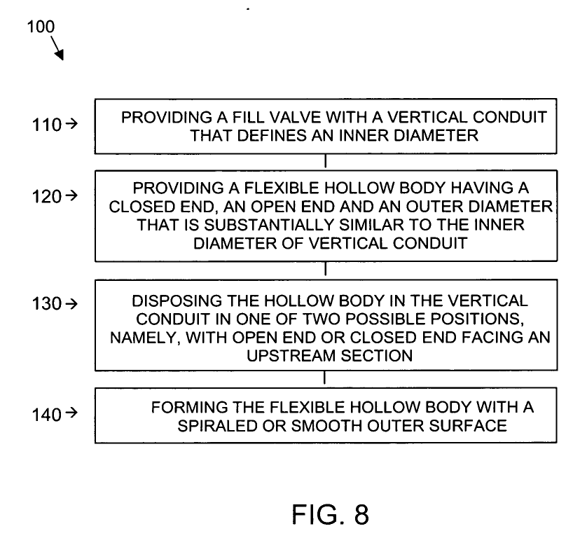

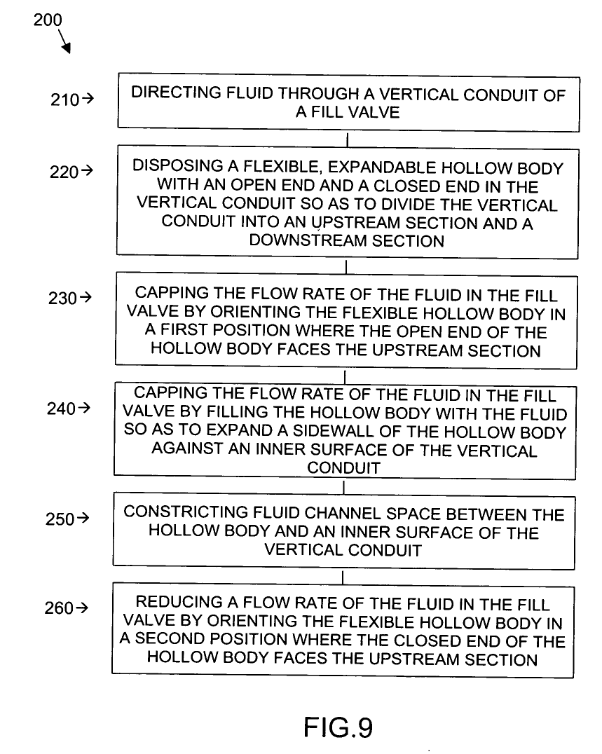

FIG. 8 illustrates a preferred method 100 of manufacturing a toilet fill valve. Step 110 includes providing a fill valve with a vertical conduit that defines an inner diameter. Step 120 comprises providing a flexible hollow body having a closed end, an open end and an outer diameter that is substantially similar to the inner diameter of vertical conduit. Step 130 comprises disposing the hollow body in the vertical conduit in one of two possible positions. In step 130, disposing the hollow body in the vertical conduit divides a passageway therein into an upstream section and a downstream section. In step 130, the hollow body may be disposed in the vertical conduit with the open end facing an upstream section or the closed end facing the upstream section.

In step 140, the flexible hollow body may be formed with a spiraled outer surface or a smooth outer surface. Step 140 may also comprise forming the hollow body with a sidewall having an outer diameter that is substantially equal or slightly less than an inner diameter of the vertical conduit so as to prevent the hollow body from shifting to a different orientation once it is disposed in the hollow body in a desired orientation.

It will also be appreciated that a method 200 for controlling fluid flow in a toilet fill valve is also provided. Step 210 comprises directing fluid through a vertical conduit of a plumbing fill valve. Step 220 comprises disposing a flexible, expandable hollow body with an open end and a closed end into the vertical conduit so as to divide the vertical conduit into an upstream section and a downstream section. Step 230 comprises capping, or regulating, the flow rate of the fluid in the fill valve by orienting the flexible 14, hollow body in a first position where the open end of the hollow body faces the upstream section.

By orienting the hollow body in the first position, step 240 comprises filling the hollow body with the fluid so as to expand a sidewall of the hollow body against an inner surface of the vertical conduit. In step 240, the water entering the hollow body through the open end expands the sidewall and causes the sidewall to press up against the inner surface of the vertical conduit. Thus, the method 200 comprises the step 250 of decreasing or reducing the flow path space between the hollow body and an inner surface of the vertical conduit.

Step 260 comprises reducing, or restricting, a flow rate of the fluid in the fill valve by orienting the flexible hollow body in a second position where the end of the hollow body faces the upstream section. In step 260, water is immediately directed into the fluid channel space between the hollow body and the inner surface of the fill valve without causing any expansion of the sidewall of the hollow body.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A toilet fill valve control device, comprising:
a hollow body including a closed end and an open end, the hollow body comprising an expandable sidewall; and
a tortuous outer surface included in the hollow body, the tortuous outer surface comprising a plurality of flow paths.

2. The device of claim 1, wherein the sidewall is composed of an elastomeric material.

3. The device of claim 1, wherein the outer surface comprises a spiraled surface.

4. The device of claim 3, wherein the plurality of flow paths comprising dual a plurality of spiraled flow paths.

5. The device of claim 1, further comprising a fill valve having a vertical conduit with an inner surface, and wherein the hollow body is configured to slidingly abut the inner surface of the vertical conduit.

6. The device of claim 5, wherein:
the vertical conduit defines a fluid passageway;
the hollow body disposed within the vertical conduit defines an upstream section and a downstream section of the fluid passageway; and
wherein the hollow body is configured to be disposed within the vertical conduit in either a first position where the open end faces the upstream section or a second position wherein closed end faces the upstream section.

7. A toilet fill valve control device, comprising:
a fill valve having a vertical conduit that includes an inner surface and defines a fluid passageway;
a hollow flexible body disposed in the vertical conduit and configured to abut the inner surface of the vertical conduit so as to define an upstream section and a downstream section of the fluid passageway, the hollow body comprising a closed end, an open end and a sidewall; and
wherein the hollow flexible body is reversible such that it may be oriented in a first position where the open end faces the upstream section, and a second position wherein the closed end faces the upstream section.

8. The device of claim 7, wherein the sidewall comprises a plurality of flow paths.

9. The device of claim 7, further comprising means for providing a tortuous flow path.

10. The device of claim 9, wherein the means for providing a tortuous flow path comprises a spiraled outer surface formed on the hollow body.

11. The device of claim 7, wherein the hollow body is composed of an expandable material.

12. The device of claim 7, wherein the hollow body caps a flow rate of fluid in the fill valve in the first position.

13. The device of claim 7, wherein the hollow body is slidingly disposed in the vertical conduit.

14. A method of manufacturing a fill valve, comprising:
providing a fill valve with a vertical conduit that defines an inner diameter;
providing a flexible hollow body having a closed end, an open end and an outer diameter that is substantially similar to the inner diameter of vertical conduit; and
disposing the hollow body in the vertical conduit in one of two possible positions.

15. The method of claim 14, wherein disposing the hollow body in the vertical conduit in one of two possible positions comprises:
dividing a passageway of the vertical conduit into an upstream section and a downstream section; and
facing the open end of the hollow body toward the upstream section.

16. The method of claim 14, wherein disposing the hollow body in the vertical conduit in one of two possible positions comprises:
dividing a passageway of the vertical conduit into an upstream section and a downstream section; and
facing the closed end of the hollow body toward the upstream section.

17. The method of claim 14, wherein providing the flexible hollow body having a closed end, an open end and an outer diameter that is substantially similar to the inner diameter of vertical conduit comprises:
forming the flexible hollow body with a spiraled outer surface.

18. A method for controlling fluid flow in a toilet fill valve, comprising:
directing fluid through a vertical conduit of a fill valve;
disposing a flexible hollow body in the vertical conduit so as to divide the vertical conduit into an upstream section and a downstream section;
capping the flow rate of the fluid in the fill valve by orienting the flexible hollow body in a first position; and
reducing a flow rate of the fluid in the fill valve by orienting the flexible hollow body in a second position.

19. The method of claim 18, wherein disposing a flexible hollow body in the vertical conduit comprises:
disposing in the vertical conduit an expandable fluid control device having an open end and a closed end.

20. The method of claim 19, wherein reducing the flow rate of the fluid in the fill valve by orienting the flexible hollow body in the second position comprises:
facing the closed end of the hollow body toward the upstream section.

21. The method of claim 19, wherein capping the flow rate of the fluid in the fill valve by orienting the flexible hollow body in the first position comprises:
facing the open end of the hollow body toward the upstream section.

22. The method of claim 23, wherein capping the flow rate of the fluid in the fill valve by orienting the flexible hollow body in the first position comprises:
filling the hollow body with the fluid so as to expand a sidewall of the hollow body against an inner surface of the vertical conduit.
